(19) United States
(12) Patent Application Publication
(10) Pub. No.: US 2019/0085906 A1
(43) Pub. Date: Mar. 21, 2019

(54) TRANSMISSION AND ACTUATOR

(71) Applicant: Nidec Corporation, Kyoto (JP)

(72) Inventor: Akihiro TODA, Kyoto (JP)

(21) Appl. No.: 16/122,918

(22) Filed: Sep. 6, 2018

Related U.S. Application Data
(60) Provisional application No. 62/559,026, filed on Sep. 15, 2017.

(30) Foreign Application Priority Data
May 29, 2018 (JP) 2018-102508

(51) Int. Cl. F16D 1/076; F16H 49/00

(52) U.S. Cl. CPC F16D 1/076; F16H 49/001

(57) ABSTRACT

A transmission includes a first shaft rotatable in a circumferential direction about a central axis extending in one direction, a second shaft rotatable in the circumferential direction and in series with the first shaft in an axial direction in which the central axis extends, an internal gear including an internal tooth portion, a housing that houses the internal gear therein, an annular external gear connected to the second shaft and including an external tooth portion that partially meshes with the internal tooth portion, a cam that is rotatable together with the first shaft and includes a connection hole that houses an end portion of the first shaft on a first side in the axial direction, and a bearing between an inner circumferential surface of the external gear and an outer circumferential surface of the cam. The connection hole includes a bottom surface at an end on the first side in the axial direction, and is open at an end on a second side in the axial direction.

### CROSS REFERENCE TO RELATED APPLICATIONS

This application claims the benefit of priority to U.S. Patent Application No. 62/559,026 filed on Sep. 15, 2017 and Japanese Patent Application No. 2018-102508 filed on May 29, 2018. The entire contents of these applications are hereby incorporated herein by reference.

### BACKGROUND OF THE INVENTION

### 1. Field of the Invention

The present invention relates to a transmission and an actuator.

### 2. Description of the Related Art

JP-A 2005-308131 describes a cup-shaped strain wave gearing device including a rigid internal gear, a cup-shaped flexible external gear arranged coaxially inside of the rigid internal gear, and a wave generator having an elliptical contour and fitted inside of the flexible external gear. The wave generator of the cup-shaped strain wave gearing device includes a cam plate having an elliptical contour, a plug to which the cam plate is coaxially fixed, and a wave bearing attached to an outer circumferential surface of the cam plate. A shaft hole, in which an input shaft can be inserted and fixed, is defined in a center of the plug.

Once the cup-shaped strain wave gearing device described in JP-A 2005-308131 starts operating, a load is applied to the plug. If an excessive load is applied to the plug, the input shaft can come off the plug. Accordingly, it is conceivable to increase the length of the shaft hole, and thus increase the area of contact between the plug and the input shaft, to increase the strength with which the plug and the input shaft are secured to each other, but this could lead to an increased size of the device.

### SUMMARY OF THE INVENTION

A transmission according to a preferred embodiment of the present invention includes a first shaft that is rotatable in a circumferential direction about a central axis extending in one direction; a second shaft that is rotatable in the circumferential direction, and arranged in series with the first shaft in an axial direction in which the central axis extends; an internal gear including an internal tooth portion; a housing that houses the internal gear therein; an annular external gear connected to the second shaft, and including an external tooth portion that partially meshes with the internal tooth portion; a cam that is rotatable together with the first shaft, and including a connection hole that houses an end portion of the first shaft on a first side in the axial direction; and a bearing located between an inner circumferential surface of the external gear and an outer circumferential surface of the cam. The connection hole includes a bottom surface at an end on the first side in the axial direction, and is open at an end on a second side in the axial direction.

An actuator according to a preferred embodiment of the present invention includes the transmission according to a preferred embodiment of the present invention and a rotary electric machine connected to one of the first shaft and the second shaft.

Preferred embodiments of the present invention are able to improve the strength with which the first shaft and the cam are secured to each other while avoiding or minimizing an increase in the size of the transmission.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating an external structure of an actuator according to a preferred embodiment of the present invention.

FIG. 2 is a side sectional view of an actuator according to a preferred embodiment of the present invention.

FIG. 3A is a perspective view illustrating an example exterior of a cam according to a preferred embodiment of the present invention.

FIG. 3B is a side sectional view illustrating the structure of the cam.

FIG. 4 is a perspective view illustrating an example exterior of an external gear according to a preferred embodiment of the present invention.

FIG. 5 is a perspective view illustrating an example exterior of an internal gear according to a preferred embodiment of the present invention.

FIG. 6 is a partial side sectional view illustrating how the cam and a first shaft are connected to each other in a speed reducer according to a preferred embodiment of the present invention in an enlarged form.

FIG. 7 is a partial side sectional view illustrating how a cam and a first shaft are connected to each other in a speed reducer according to a first modification of a preferred embodiment of the present invention in an enlarged form.

FIG. 8 is a partial side sectional view illustrating how a cam and a first shaft are connected to each other in a speed reducer according to a second modification of a preferred embodiment of the present invention in an enlarged form.

FIG. 9 is a partial side sectional view illustrating how a cam and a first shaft are connected to each other in a speed reducer according to a third modification of a preferred embodiment of the present invention in an enlarged form.

FIG. 10 is a partial side sectional view illustrating how a cam and a first shaft are connected to each other in a speed reducer according to a fourth modification of a preferred embodiment of the present invention in an enlarged form.

### DETAILED DESCRIPTION OF THE PREFERRED EMBODIMENTS

Hereinafter, preferred embodiments of the present invention will be described in detail with reference to the accompanying drawings.

### 1. OVERALL STRUCTURE OF ACTUATOR

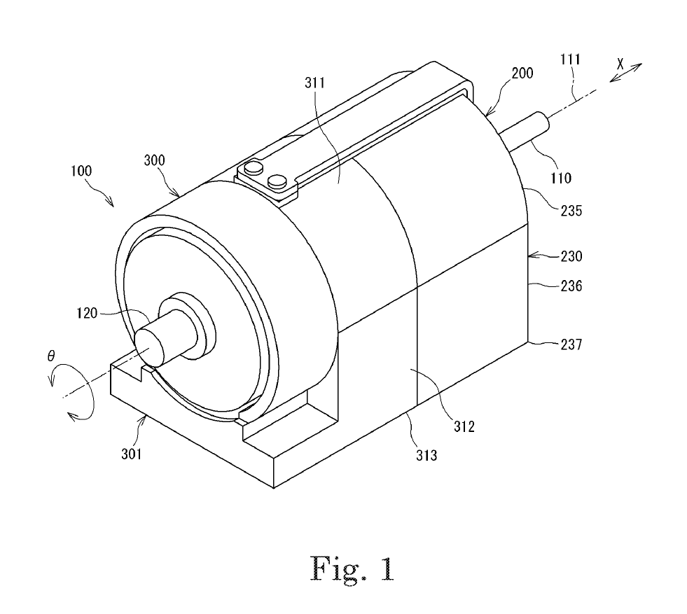

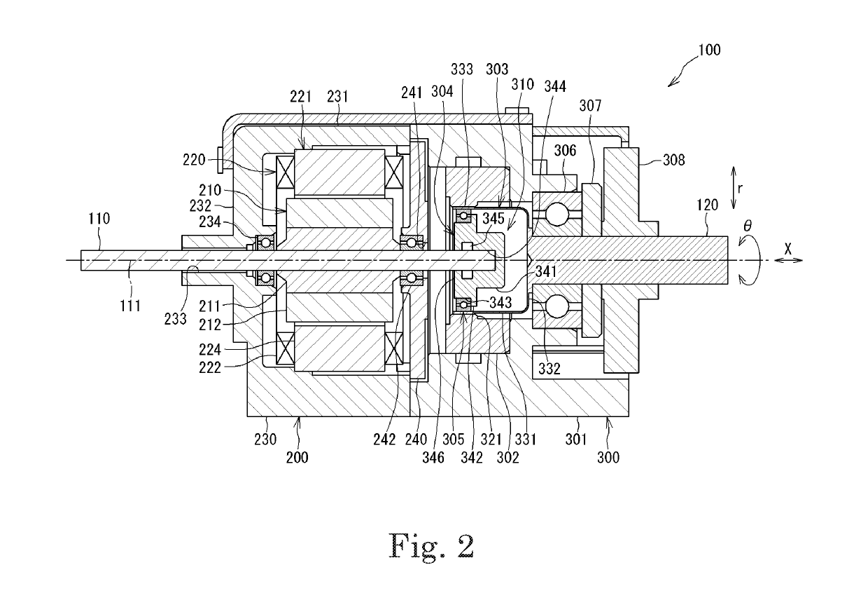

FIG. 1 is a perspective view illustrating the external structure of an actuator 100 according to a preferred embodiment of the present invention. FIG. 2 is a side sectional view of the actuator 100 according to the present preferred embodiment. Referring to FIGS. 1 and 2, the actuator 100 includes a motor (i.e., a rotary electric machine) 200 and a speed reducer (i.e., a transmission) 300. Note that the rotary electric machine may not necessarily be a motor, but may alternatively be an electric generator or a motor generator, which is able to function as both a motor and an electric generator. Also note that the transmission may not necessarily be a speed reducer, but may alternatively be a speed increaser.

### 2. STRUCTURE OF MOTOR

The structure of the motor 200 will now be described below with reference to FIG. 2. The motor 200 is that is rotatable a first shaft 110, which is a rotating shaft. The motor 200 includes a rotor 210 fixed to the first shaft 110, and a stator 220 arranged in the shape of a circular ring around the rotor 210. In this preferred embodiment, the rotor 210 is a field component, while the stator 220 is an armature. Note that the rotor 210 and the stator 220 may alternatively be an armature and a field component, respectively. It is assumed in the following description that an axial direction in which a central axis 111 of the first shaft 110 extends is an “x direction”, that a circumferential direction about the central axis 111 is a “θ direction”, and that radial directions centered on the central axis 111 are each an “r direction”.

The rotor 210 includes a cylindrical yoke 211, and a permanent magnet 212 fixed to an outer circumferential surface of the yoke 211. A portion of the first shaft 110 extending in the x direction is housed in the yoke 211, and the yoke 211 is fixed to the first shaft 110. The permanent magnet 212 is arranged on an outer circumference of the yoke 211. The permanent magnet 212 is a ring magnet including south and north poles arranged to alternate with each other in the θ direction, and arranged at regular intervals in the θ direction. Each magnetic pole of the permanent magnet 212 is arranged on a surface facing outward in an r direction, i.e., on a surface facing the stator 220.

The stator 220 includes a core 221 and a plurality of coils 222. The core 221 is made of a soft magnetic material, and includes a plurality of teeth 224. The teeth 224 are arranged at regular intervals in the θ direction. Each tooth 224 is arranged to extend in an r direction toward the central axis 111. The number of coils 222 and the number of teeth 224 are equal to each other.

The number of coils 222, that is, the number of slots, is different from the number of poles of the permanent magnet 212. In the case of a three-phase motor, for example, the number of slots is a multiple of three, and the number of poles is an even number.

The motor 200 further includes a casing 230 and a cover 240. The casing 230 includes a tubular portion 231 and a plate-shaped cover portion 232. The tubular portion 231 has a columnar space defined inside thereof, and one end of the tubular portion 231, i.e., an end portion of the tubular portion 231 in the x direction in the example of FIG. 2, is closed by the cover portion 232. The casing 230 is that houses the rotor 210 and the stator 220.

The tubular portion 231 of the casing 230 is arranged to have an inside diameter substantially equal to an outside diameter of the core 221. The core 221 is fixed to an inner circumferential surface of the tubular portion 231 through, for example, an adhesive. The stator 220 is thus fixed to an inner circumferential surface of the casing 230. The cover portion 232 includes a circular hole 233 defined in a center thereof in the r directions. The hole 233 is arranged to have a diameter greater than that of the first shaft 110, and the first shaft 110 is arranged to pass through the hole 233. A bearing 234 in the shape of a circular ring is fitted around the hole 233, and the bearing 234 is arranged to rotatably support the first shaft 110.

The casing 230 is arranged to have an external shape being a combination of a semicircle and a rectangle when viewed in the x direction. In other words, the casing 230 includes a semicircular portion 235 and a flange portion 236, which are semicircular and rectangular, respectively, when viewed in the x direction. A semicircular exterior of the semicircular portion 235 is arranged to be concentric with an inner circumferential surface of the semicircular portion 235. That is, the exterior of the semicircular portion 235 is an arc-shaped surface which is semicircular with the central axis of the first shaft 110 as a center. Meanwhile, the flange portion 236 includes two right-angled corner portions 237 each of which projects in an r direction, and the flange portion 236 is joined to the speed reducer 300 through bolts at the corner portions 237.

The cover 240 is a circular plate having a diameter slightly greater than that of a circular opening of the casing 230. The cover 240 is fixed at the opening of the casing 230 to close the opening. The cover 240 includes a circular hole 241 defined in a center thereof in the r directions. A bearing 242 in the shape of a circular ring is fitted in the hole 241. The bearing 242 is arranged to rotatably support the first shaft 110.

Once electric currents are supplied to the coils 222 of the stator 220, which is the armature, in the motor 200 having the above-described structure, action of electromagnetic induction causes the first shaft 110 to rotate in the θ direction.

### 3. STRUCTURE OF SPEED REDUCER

The structure of the speed reducer 300 will now be described below with reference to FIG. 2. The speed reducer 300 is a strain wave gearing device arranged to transfer rotation from the first shaft 110 to a second shaft 120, which is a rotating shaft arranged to extend in the x direction, while changing the speed of the rotation. The speed reducer 300 includes a housing 301, an internal gear 302, an external gear 303, and a wave generator 310.

The first shaft 110 is arranged to extend in the x direction from the cover 240, and the wave generator 310 is connected to one end of the first shaft 110. The wave generator 310 includes a cam 304 and a flexible bearing 305.

The actuator 100 according to the present preferred embodiment can be oriented such that the x direction is the vertical direction, for example. In this case, the actuator 100 may be oriented such that the motor 200 and the speed reducer 300 are arranged on the lower side and the upper side, respectively. When the actuator 100 is oriented in this manner, an end (on one side) of the first shaft 110 which is connected to the wave generator 310 is an upper end, while an opposite end (on another side) of the first shaft 110 is a lower end.

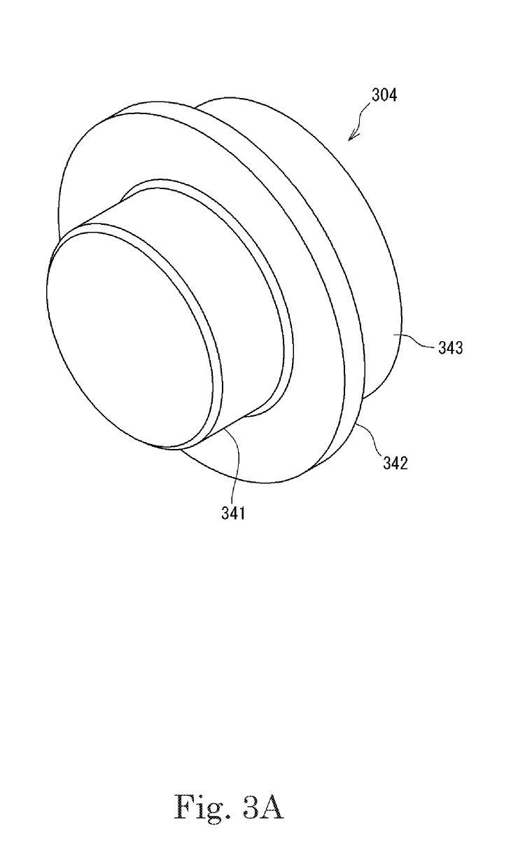

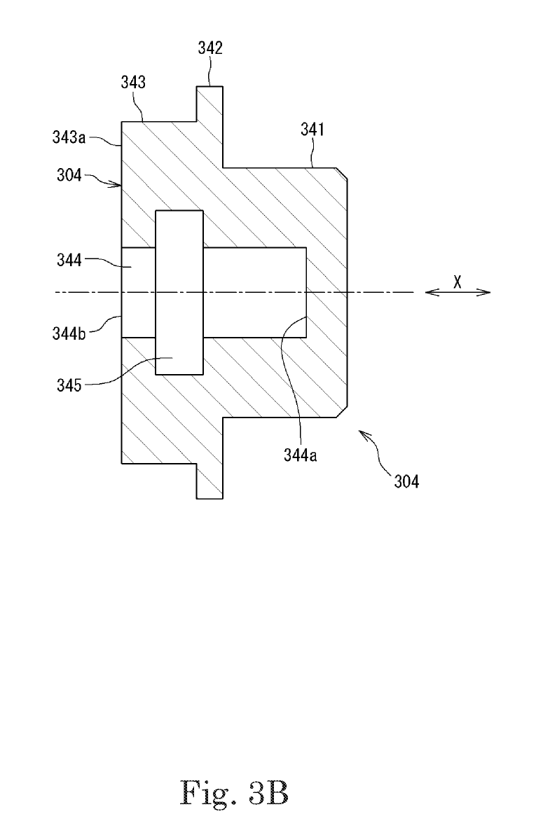

The cam 304 is fixed to one end portion of the first shaft 110. FIG. 3A is a perspective view illustrating an exterior of the cam 304, and FIG. 3B is a side sectional view illustrating the structure of the cam 304. The cam 304 includes a small diameter portion 341 and a large diameter portion 342 arranged in the x direction. Each of the small diameter portion 341 and the large diameter portion 342 is arranged to have a circular exterior centered on the central axis 111 of the first shaft 110, and the large diameter portion 342 is arranged to have an outside diameter greater than that of the small diameter portion 341. The large diameter portion 342 is arranged closer to the motor 200 than is the small diameter portion 341. An outer circumferential portion of the large diameter portion 342 includes an elliptical decreased diameter portion 343, and the flexible bearing 305 is fitted to the decreased diameter portion 343 (see FIG. 2).

The cam 304 includes a connection hole 344 defined in a center thereof in the r directions (see FIG. 3B). The connection hole 344 is closed at an end on one side in the x direction, and is open at an end on another side in the x direction. That is, the connection hole 344 has a bottom surface 344a at the end on the one side in the x direction, and an opening 344b at the end on the other side in the x direction. The connection hole 344 as described above is arranged to extend in the x direction over a range from an end surface 343a of the cam 304 on a side on which the decreased diameter portion 343 lies to an intermediate point in the small diameter portion 341 in the x direction. The end portion of the first shaft 110 on the one side in the x direction is housed in the connection hole 344, and the end portion of the first shaft 110 is fixed in the connection hole 344 (see FIG. 2). This allows the cam 304 to rotate in the θ direction together with the first shaft 110.

When the actuator 100 is oriented such that the motor 200 and the speed reducer 300 are arranged on the lower side and the upper side, respectively, with the x direction extending in the vertical direction, the large diameter portion 342 is arranged on the lower side of the small diameter portion 341. In this case, the bottom surface 344a is arranged at an upper end of the connection hole 344, while the opening 344b is arranged at a lower end of the connection hole 344.

An inner circumferential surface of the cam 304 defining the connection hole 344 includes a recessed portion 345 recessed in the r directions. The recessed portion 345 is arranged in the shape of a circular ring, extending 360 degrees in the θ direction along the inner circumferential surface of the cam 304 defining the connection hole 344.

An example of the recessed portion 345 is illustrated in FIG. 3B. This example recessed portion 345 is arranged between both ends of the cam 304 in the x direction. More specifically, the recessed portion 345 is arranged at an intermediate portion of the connection hole 344 in the x direction. In addition, the recessed portion 345 is arranged to overlap with the large diameter portion 342 and the decreased diameter portion 343 of the cam 304 when viewed in the r directions.

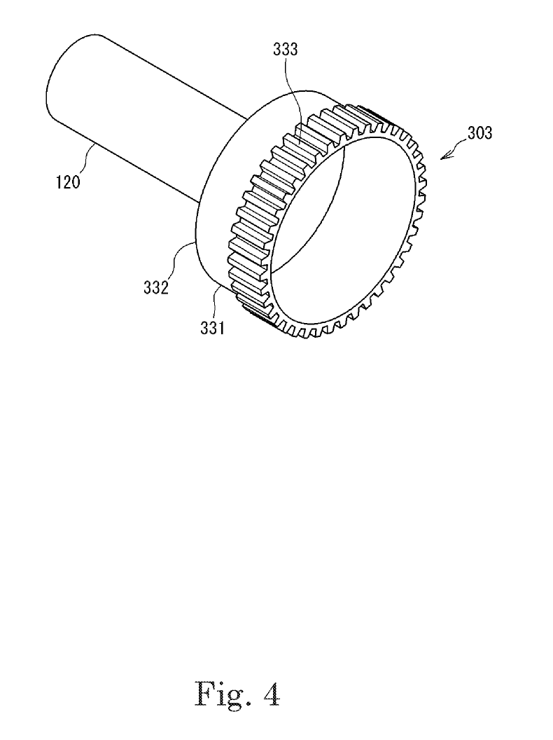

FIG. 4 is a perspective view illustrating an exterior of the external gear 303. The external gear 303 is a cup-shaped external gear which is closed at one end and open at another end in the x direction. That is, the external gear 303 includes a cylindrical portion 331 and a disk-shaped cover portion 332, and the cover portion 332 is arranged to close one end of the cylindrical portion 331. The cylindrical portion 331 is a thin cylinder made of a metal, such as, for example, carbon steel, and is flexible. The cylindrical portion 331 includes an external tooth portion 333 at another end thereof, more specifically, at an outer circumference of an end portion thereof closer to the motor 200.

The cover portion 332 includes surfaces on both sides in the x direction, and the second shaft 120 is arranged to extend in the x direction from a center in the r directions of one of the surfaces of the cover portion 332 on an opposite side to the surface thereof on which the cylindrical portion 331 is arranged. The external gear 303 is arranged to be coaxial with the first shaft 110, and the second shaft 120 and the first shaft 110 are arranged coaxially in series (see FIG. 2). The second shaft 120 is fixed to the cover portion 332, and is that is rotatable in the θ direction together with the cover portion 332.

Reference will now be made to FIG. 2. The cam 304 is housed in the cylindrical portion 331 of the external gear 303. The flexible bearing 305 is arranged between an inner circumferential surface of the cylindrical portion 331 of the external gear 303 and the decreased diameter portion 343 (i.e., an outer circumferential surface) of the cam 304. This allows the external gear 303 and the cam 304 to rotate in the θ direction relative to each other. The flexible bearing 305 includes a flexible outer race member 351, a flexible inner race member 352, and a plurality of balls 353 housed between the outer race member 351 and the inner race member 352, and is capable of being deformed in the r directions

The cam 304 is a metal block made of, for example, carbon steel, and is arranged to have a high rigidity. Thus, the flexible bearing 305, which is attached to the cam 304, is fitted to an outer circumferential surface of the decreased diameter portion 343 of the cam 304, and is deformed into an elliptical shape. In addition, since an inner circumferential surface of the external gear 303 is in contact with the flexible bearing 305, the cylindrical portion 331 of the external gear 303 is deformed into an elliptical shape matching an exterior of the flexible bearing 305.

Similarly to the casing 230 of the motor 200, the housing 301 is arranged to have a shape being a combination of a semicircle and a rectangle when viewed in the x direction (see FIG. 1). In other words, the housing 301 includes a semicircular portion 311 and a flange portion 312, which are semicircular and rectangular, respectively, when viewed in the x direction. The semicircular portion 311 is arranged to have a diameter equal to that of the semicircular portion 235 of the casing 230, and the flange portion 312 includes two right-angled corner portions 313 each of which projects in an r direction. The shape of the flange portion 312 of the housing 301 and the shape of the flange portion 236 of the casing 230 match each other, and the flange portion 312 and the flange portion 236 are fixed to each other through the bolts.

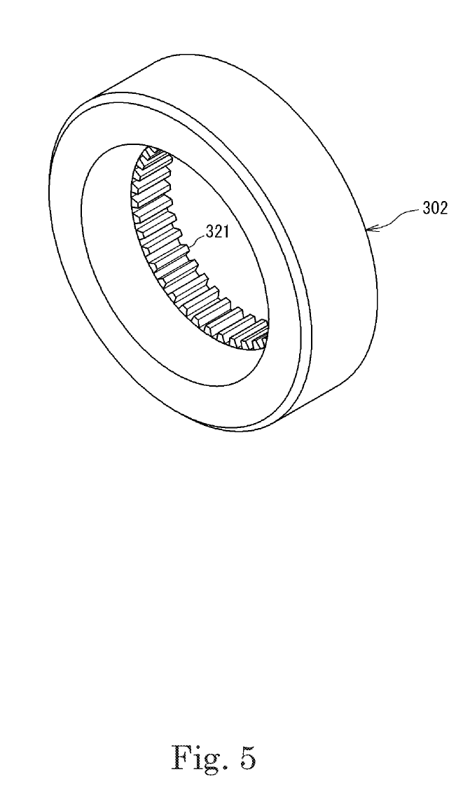

In addition, referring to FIG. 2, the housing 301 has an interior space having a circular section, and the internal gear 302 is housed in this interior space. FIG. 5 is a perspective view illustrating an example exterior of the internal gear 302. The internal gear 302 is in the shape of a circular ring, and is press fitted into the interior space of the housing 301. The housing 301 and the internal gear 302 are fixed to each other. The internal gear 302 includes an internal tooth portion 321 defined in an inner circumference thereof.

Reference will now be made to FIG. 2. The external gear 303 is arranged inside of the internal gear 302. As mentioned above, the external gear 303 is deformed into a shape being elliptical when viewed in the x direction. Accordingly, teeth of the external tooth portion 333 of the external gear 303 which correspond to a major axis mesh with the internal tooth portion 321 of the internal gear 302, while teeth of the external tooth portion 333 which correspond to a minor axis are apart from the internal tooth portion 321.

The number of teeth of the internal tooth portion 321 of the internal gear 302 is different from the number of teeth of the external tooth portion 333 of the external gear 303. For example, when n denotes a positive integer, the number of teeth of the internal tooth portion 321 is arranged to be greater than the number of teeth of the external tooth portion 333 by 2n. Once the first shaft 110 starts rotating, the cam 304 starts rotating together with the first shaft 110. The rotation of the cam 304 causes the external gear 303 to be elastically deformed such that the major axis of the elliptical shape rotates. Accordingly, meshing positions between the external tooth portion 333 and the internal tooth portion 321 move in the θ direction. That is, the wave generator 310 causes the external gear 303 to be deformed in accordance with the rotation of the first shaft 110 such that meshing positions between the internal gear 302 and the external gear 303 shift in the θ direction. Every time the first shaft 110 completes a single rotation, the external gear 303 rotates in the θ direction by an amount corresponding to a difference between the number of teeth of the internal tooth portion 321 and the number of teeth of the external tooth portion 333. As a result, the rotation of the first shaft 110 is transferred to the second shaft 120 while the speed of the rotation is reduced.

A bearing 306 is attached to the housing 301, and the bearing 306 is arranged to support the second shaft 120 such that the second shaft 120 is capable of rotating about the central axis 111. In addition, a washer 307 and a disk-shaped plate member 308 are attached to the second shaft 120 such that the bearing 306, the washer 307, and the plate member 308 are arranged in the x direction.

### 4. STRUCTURE OF GEAR MECHANISM

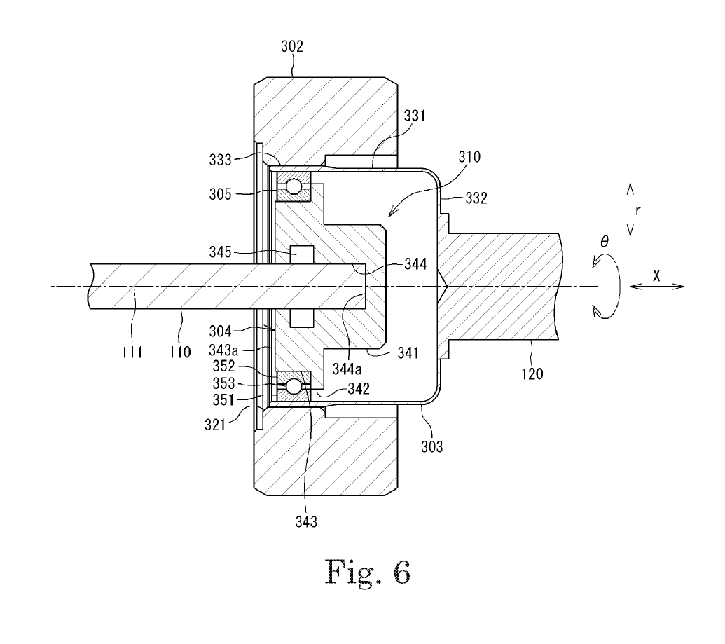

FIG. 6 is a partial side sectional view illustrating how the cam 304 and the first shaft 110 are connected to each other in the speed reducer according to the present preferred embodiment in an enlarged form. The cam 304 includes the connection hole 344, which is arranged to extend in the x direction, and the end portion of the first shaft 110 on the one side in the x direction is housed in the connection hole 344. As described above, the connection hole 344 is closed at the end on the one side in the x direction, and is open at the end on the other side in the x direction. That is, the connection hole 344 has the bottom surface 344a at the end on the one side in the x direction.

The end portion of the first shaft 110 on the one side in the x direction is press fitted into the connection hole 344 of the cam 304. At this time, the first shaft 110 is press fitted into the connection hole 344 until an end surface of the first shaft 110 on the one side in the x direction is brought into contact with the bottom surface 344a. Therefore, the first shaft 110 and the cam 304 are in contact with each other not only between an outer circumferential surface of the end portion of the first shaft 110 on the one side in the x direction and the inner circumferential surface of the cam 304 defining the connection hole 344, but also between the end surface of the first shaft 110 on the one side in the x direction and the bottom surface 344a. Thus, provision of the bottom surface 344a contributes to increasing the total area of contact between the first shaft 110 and the cam 304 without the need to increase the dimension of the connection hole 344 measured in the x direction. This in turn contributes to improving the strength with which the first shaft 110 and the cam 304 are secured to each other while avoiding or minimizing an increase in the size of the speed reducer 300. In addition, when a load acting toward the bottom surface 344a in the x direction is applied to the first shaft 110, the bottom surface 344a serves to prevent the first shaft 110 from protruding out of the cam 304.

In addition, the connection hole 344 is arranged to extend in the x direction over the range from the end surface 343a of the cam 304 on the side on which the decreased diameter portion 343 lies to the intermediate point in the small diameter portion 341 in the x direction. That is, the bottom surface 344a is defined in the small diameter portion 341. Therefore, the end surface of the first shaft 110 on the one side in the x direction is arranged in the small diameter portion 341. In other words, the small diameter portion 341 is arranged to overlap in the x direction with the end surface of the first shaft 110 on the one side in the x direction. This arrangement contributes to increasing the total area of contact between the first shaft 110 and the cam 304, and to improving the strength with which the first shaft 110 and the cam 304 are secured to each other.

In addition, as described above, the recessed portion 345 is arranged at the intermediate portion of the connection hole 344 in the x direction. The recessed portion 345 is arranged opposite to the external tooth portion 333 of the external gear 303 in the radial directions (i.e., the r directions). More specifically, in the preferred embodiment illustrated in FIG. 6, the recessed portion 345 is arranged opposite to a portion of the external tooth portion 333 in the r directions. That is, the external tooth portion 333 is arranged on straight lines extending in the r directions from the position of the recessed portion 345. In other words, a range over which the recessed portion 345 extends in the x direction overlaps with a range over which the external tooth portion 333 extends in the x direction.

The diameter of the connection hole 344 before a portion of the first shaft 110 is housed therein is slightly smaller than the diameter of the first shaft 110. The first shaft 110 is press fitted into the connection hole 344 having such a dimension, and the first shaft 110 and the cam 304 are thus connected to each other. When the first shaft 110 is press fitted into the connection hole 344, the shape of an outer circumference of the first shaft 110 can be transferred to the cam 304 to slightly deform the shape of an outer circumference of the cam 304. However, in the range over which the recessed portion 345 extends in the x direction, the cam 304 and the first shaft 110 are not in contact with each other, and the shape of the outer circumference of the first shaft 110 is not transferred to the cam 304. Therefore, in the range over which the recessed portion 345 extends in the x direction, the likelihood of a deformation of the shape of the outer circumference of the cam 304 is reduced.

The decreased diameter portion 343 of the large diameter portion 342 is arranged opposite to the external tooth portion 333 in the radial directions (i.e., the r directions). In addition, a portion of the decreased diameter portion 343 is arranged opposite to the recessed portion 345 in the r directions. The flexible bearing 305 is arranged on the decreased diameter portion 343. That is, the flexible bearing 305 is arranged opposite to each of the recessed portion 345 and the external tooth portion 333 in the r directions. Therefore, the flexible bearing 305 is arranged at a portion of the outer circumference of the cam 304 where the likelihood of a deformation of the shape of the outer circumference of the cam 304 is reduced, and the external tooth portion 333 is deformed into an elliptical shape matching the shape of the outer circumference of the cam 304 through the flexible bearing 305. Accordingly, an influence of the shape of the outer circumference of the first shaft 110 on the shape of the external tooth portion 333 is reduced to prevent a deterioration in accuracy with which the internal gear 302 and the external gear 303 mesh with each other.

The depth of the recessed portion 345, that is, the dimension of the recessed portion 345 measured in the r directions, is equal to or smaller than a half of a maximum thickness, measured in the r directions, of a portion of the cam 304 which extends over a range over which the cam 304 is joined to the flexible bearing 305, that is, a portion of the cam 304 which corresponds to the decreased diameter portion 343. This contributes to ensuring a sufficient mechanical strength of the cam 304 while avoiding an excessive reduction in the thickness, measured in the r directions, of a portion of the cam 304 in which the recessed portion 345 is defined.

### 5. EXAMPLE MODIFICATIONS

Speed reducers according to example modifications of the present preferred embodiment will now be described below.

### 5-1. First Modification

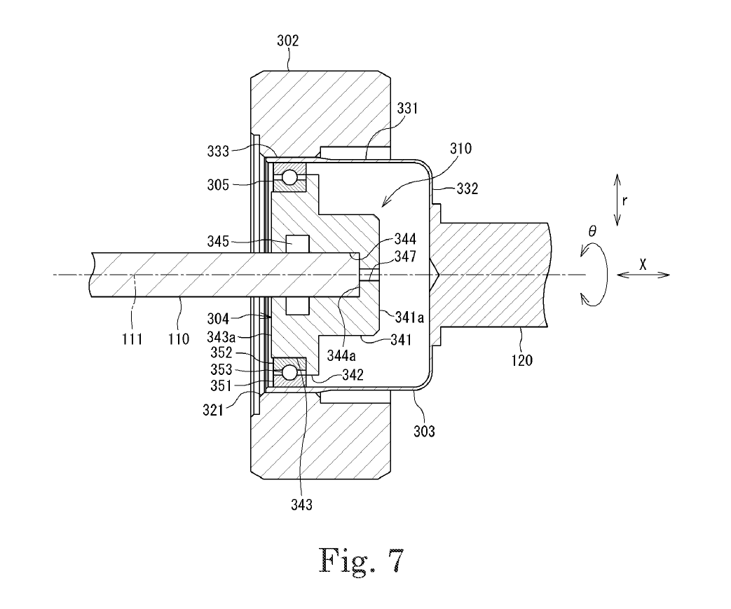

FIG. 7 is a partial side sectional view illustrating how a cam 304 and a first shaft 110 are connected to each other in a speed reducer 300 according to a first modification of the above-described preferred embodiment in an enlarged form. In this modification, the cam 304 includes a through hole 347 arranged to extend from an end surface 341a of the cam 304 on a side on which a small diameter portion 341 lies to a bottom surface 344a of a connection hole 344.

When an actuator 100 is oriented such that a motor 200 and the speed reducer 300 are arranged on the lower side and the upper side, respectively, with the x direction extending in the vertical direction, the through hole 347 is arranged to extend from the end surface 341a of the cam 304 on the upper side to the bottom surface 344a of the connection hole 344.

When one end portion of the first shaft 110 is press fitted into the connection hole 344 of the cam 304 according to the present modification, an air in a space defined by an end surface of the first shaft 110, the bottom surface 344a, and an inner circumferential surface of the cam 304 defining the connection hole 344 is discharged through the through hole 347. Accordingly, the air does not stay in the above space, which leads to improved workability in the press fitting of the first shaft 110.

### 5-2. Second Modification

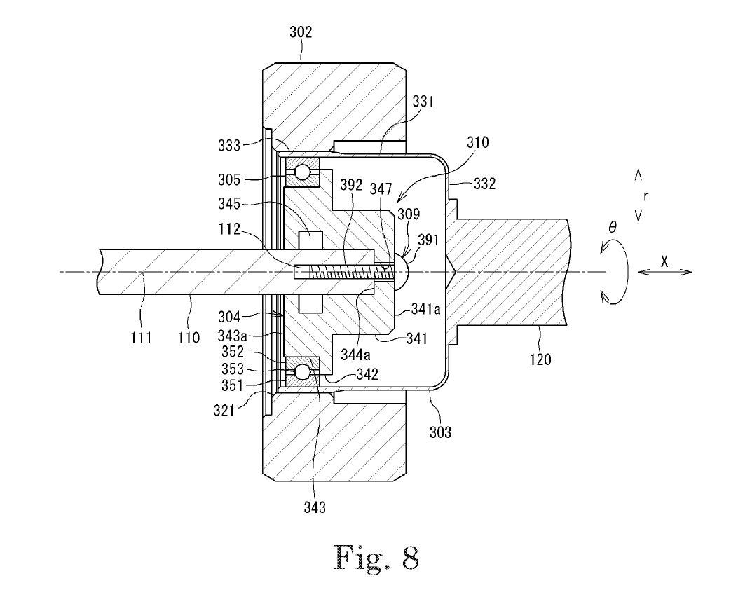

FIG. 8 is a partial side sectional view illustrating how a cam 304 and a first shaft 110 are connected to each other in a speed reducer 300 according to a second modification of the above-described preferred embodiment in an enlarged form. In this modification, the first shaft 110 and the cam 304 are screwed to each other through a screw 309.

The first shaft 110 includes a screw hole 112 arranged to open in an end surface of the first shaft 110 on the one side in the x direction. The screw hole 112 is provided with a female screw portion. In addition, the cam 304 includes a through hole 347 arranged to extend from an end surface 341a of the cam 304 on the one side in the x direction to a bottom surface 344a of a connection hole 344. In this modification, the screw hole 112 is defined in a center of the first shaft 110 in the r directions, while the through hole 347, which is circular when viewed in the x direction, is defined in a center, in the r directions, of the end surface 341a of the cam 304 on a side on which a small diameter portion 341 lies.

When an actuator 100 is oriented such that a motor 200 and the speed reducer 300 are arranged on the lower side and the upper side, respectively, with the x direction extending in the vertical direction, the screw hole 112 is defined at an upper end of the first shaft 110. In addition, the through hole 347 is arranged to extend from the end surface 341a of the cam 304 on the upper side to the bottom surface 344a of the connection hole 344.

The screw 309 includes a head portion 391 and a shank portion 392. The head portion 391 is disk-shaped or hemispherical, and the head portion 391 is arranged to have a diameter greater than that of the through hole 347. Meanwhile, the shank portion 392 is columnar, and the shank portion 392 is arranged to have a diameter smaller than that of the through hole 347. Accordingly, the shank portion 392 passes through the through hole 347, while an end surface of the head portion 391 on a side on which the shank portion 392 lies is brought into contact with the end surface 341a of the cam 304 on the side on which the small diameter portion 341 lies.

The shank portion 392 includes a male screw portion. The male screw portion of the shank portion 392 is screwed into the female screw portion of the screw hole 112. The first shaft 110 and the cam 304 are thus fixed to each other through the screw 309, so that the first shaft 110 is prevented from coming off the cam 304.

When the shank portion 392 of the screw 309 has been screwed into the screw hole 112 of the first shaft 110 as described above, a large diameter portion 342 of the cam 304 overlaps in the x direction with an end of the screw 309 on an opposite side to the head portion 391 in the x direction, that is, a tip of the shank portion 392. In other words, the position of the tip of the shank portion 392 in the x direction lies within a range of the large diameter portion 342 in the x direction. When the actuator 100 is oriented such that the motor 200 and the speed reducer 300 are arranged on the lower side and the upper side, respectively, with the x direction extending in the vertical direction, the tip of the shank portion 392 is arranged at a lower end of the shank portion 392.

The above-described configuration ensures a large dimension, in the x direction, of an area over which the screw hole 112 of the first shaft 110 and the shank portion 392 of the screw 309 are in contact with each other, and contributes to improving the strength with which the first shaft 110 and the cam 304 are secured to each other.

### 5-3. Third Modification

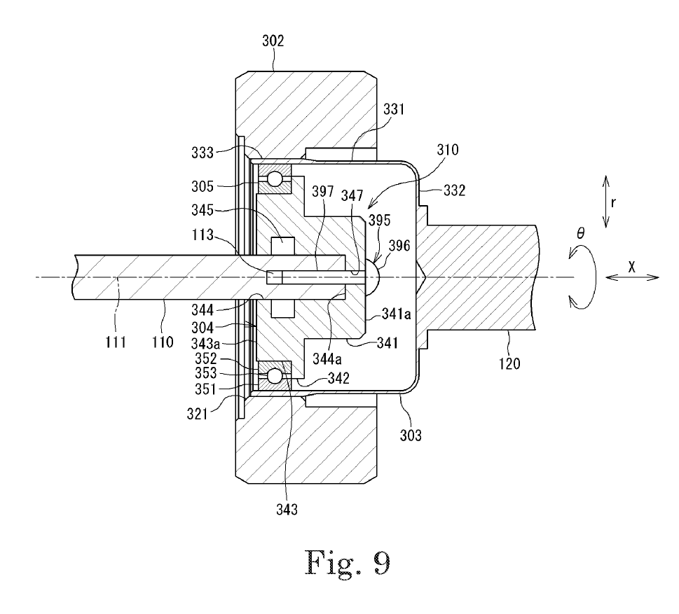

FIG. 9 is a partial side sectional view illustrating how a cam 304 and a first shaft 110 are connected to each other in a speed reducer 300 according to a third modification of the above-described preferred embodiment in an enlarged form. In this modification, the first shaft 110 and the cam 304 are coupled to each other through a joining member 395, and the first shaft 110, the cam 304, and the joining member 395 are joined together through welding.

The first shaft 110 includes an insert hole 113 arranged to open in an end surface of the first shaft 110 on the one side in the x direction. The insert hole 113 is a columnar hole. In addition, the cam 304 includes a through hole 347 arranged to extend from an end surface 341a of the cam 304 on the one side in the x direction to a bottom surface 344a of a connection hole 344. In this modification, the insert hole 113 is defined in a center of the first shaft 110 in the r directions, while the through hole 347, which is circular when viewed in the x direction, is defined in a center, in the r directions, of the end surface 341a of the cam 304 on a side on which a small diameter portion 341 lies.

When an actuator 100 is oriented such that a motor 200 and the speed reducer 300 are arranged on the lower side and the upper side, respectively, with the x direction extending in the vertical direction, the insert hole 113 is defined at an upper end of the first shaft 110. In addition, the through hole 347 is arranged to extend from the end surface 341a of the cam 304 on the upper side to the bottom surface 344a of the connection hole 344.

The joining member 395 includes a head portion 396 and a shank portion 397. The head portion 396 is disk-shaped or hemispherical, and the head portion 396 is arranged to have a diameter greater than that of the through hole 347. Meanwhile, the shank portion 397 is columnar, and the shank portion 397 is arranged to have a diameter smaller than that of the through hole 347. In addition, the shank portion 397 is arranged to have a diameter smaller than that of the insert hole 113. The shank portion 397 as described above is arranged to pass through the through hole 347, and is housed in the insert hole 113. At this time, an end surface of the head portion 396 on a side on which the shank portion 397 lies is brought into contact with the end surface 341a of the cam 304 on the one side in the x direction.

With the joining member 395 being arranged in the above-described manner with respect to the first shaft 110 and the cam 304, the first shaft 110, the cam 304, and the joining member 395 are welded together. The first shaft 110 and the cam 304 are thus fixed to each other, so that the first shaft 110 is prevented from coming off the cam 304.

When the shank portion 397 of the joining member 395 has been housed in the insert hole 113 of the first shaft 110 as described above, a large diameter portion 342 of the cam 304 overlaps in the x direction with an end of the joining member 395 on an opposite side to the head portion 396 in the x direction, that is, a tip of the shank portion 397. In other words, the position of the tip of the shank portion 397 in the x direction lies within a range of the large diameter portion 342 in the x direction. When the actuator 100 is oriented such that the motor 200 and the speed reducer 300 are arranged on the lower side and the upper side, respectively, with the x direction extending in the vertical direction, the tip of the shank portion 397 is arranged at a lower end of the shank portion 397.

The above-described configuration ensures a large dimension, in the x direction, of an area over which the insert hole 113 of the first shaft 110 and the shank portion 397 of the joining member 395 are welded to each other, and contributes to improving the strength with which the first shaft 110 and the cam 304 are secured to each other.

### 5-4. Fourth Modification

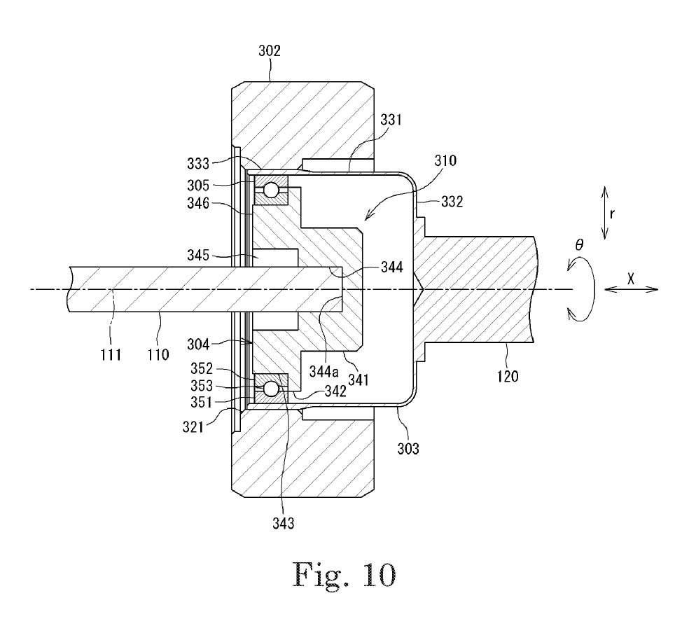

FIG. 10 is a partial side sectional view illustrating how a cam 304 and a first shaft 110 are connected to each other in a speed reducer 300 according to a fourth modification of the above-described preferred embodiment in an enlarged form. In this modification, the cam 304 includes a recessed portion 345 arranged to extend over a range from an intermediate point in a connection hole 344 in the x direction to an end portion 346 of the cam 304 on a side on which a large diameter portion 342 lies. That is, the recessed portion 345 is arranged to be open at the end portion 346 of the cam 304 on the side on which the large diameter portion 342 lies. The first shaft 110 is arranged to extend in the x direction over a range including the end portion 346.

Referring to FIG. 10, the recessed portion 345 is arranged to overlap with the large diameter portion 342 in the x direction. In other words, the recessed portion 345 is defined in the large diameter portion 342. Note that not the entire recessed portion 345 but only a portion of the recessed portion 345 may be arranged to overlap with the large diameter portion 342 in the x direction.

In addition, as described above, the recessed portion 345 is arranged to extend in the x direction up to the end portion 346 of the large diameter portion 342, and is arranged to be open at the end portion 346. When an actuator 100 is oriented such that a motor 200 and the speed reducer 300 are arranged on the lower side and the upper side, respectively, with the x direction extending in the vertical direction, the end portion 346 is arranged at a lower end of the cam 304, and the recessed portion 345 opens downwardly.

Thus, the first shaft 110 and the cam 304 are not in contact with each other over a range extending up to the end portion 346 of the cam 304 on the side on which the large diameter portion 342 lies, on which the recessed portion 345 is defined, and this contributes to preventing the shape of an outer circumference of the first shaft 110 from being transferred to the cam 304 when the first shaft 110 is press fitted into the connection hole 344. Therefore, in the range extending up to the end portion 346 on the side on which the recessed portion 345 is defined, the likelihood of a deformation of the shape of an outer circumference of the cam 304 is reduced. In addition, connection of the first shaft 110 to the cam 304 is made easier because the connection hole 344 is widely open at the end portion 346 of the cam 304 on the side on which the large diameter portion 342 lies.

### 5-5. Other Example Modifications

In the actuator 100 according to the above-described preferred embodiment of the present invention, the first shaft 110 is connected to the motor 200, which is an example of a rotary electric machine. Note, however, that actuators according to other preferred embodiments of the present invention may have another structure. In another preferred embodiment of the present invention, an electric generator, which is another example of a rotary electric machine, may be connected to a first shaft 110. In yet another preferred embodiment of the present invention, a second shaft 120 may be connected to a rotary electric machine, such as, for example, a motor, an electric generator, or a motor generator.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A transmission comprising:
a first shaft that is rotatable in a circumferential direction about a central axis extending in one direction;
a second shaft that is rotatable in the circumferential direction, and arranged in series with the first shaft in an axial direction in which the central axis extends;
an internal gear including an internal tooth portion;
a housing that houses the internal gear therein;
an annular external gear connected to the second shaft, and including an external tooth portion that partially meshes with the internal tooth portion;
a cam that is rotatable together with the first shaft, and including a connection hole that houses an end portion of the first shaft on a first side in the axial direction; and
a bearing located between an inner circumferential surface of the external gear and an outer circumferential surface of the cam; wherein
the connection hole includes a bottom surface at an end on the first side in the axial direction, and is open at an end on a second side in the axial direction.

2. The transmission according to claim 1, wherein the cam includes a through hole extending from an end surface of the cam on the first side in the axial direction to the bottom surface.

3. The transmission according to claim 2, further comprising a screw including a head portion and a shank portion; wherein
the first shaft includes a screw hole opening in an end surface of the first shaft on the first side in the axial direction;
the head portion has a diameter greater than that of the through hole; and
the shank portion extends through the through hole, and is screwed into the screw hole.

4. The transmission according to claim 2, further comprising a joining member including a head portion and a shank portion; wherein
the first shaft includes an insert hole opening in an end surface of the first shaft on the first side in the axial direction;
the head portion has a diameter greater than that of the through hole;
the shank portion extends through the through hole, and is inserted into the insert hole; and
the joining member, the cam, and the first shaft are welded together.

5. The transmission according to claim 1, wherein
the cam includes a large diameter portion and a small diameter portion on the first side of the large diameter portion in the axial direction, at least a portion of the large diameter portion being opposite to the external tooth portion in radial directions centered on the central axis; and
the small diameter portion overlaps in the axial direction with the end portion of the first shaft on the first side in the axial direction.

6. The transmission according to claim 3, wherein
the cam includes a large diameter portion and a small diameter portion on the first side of the large diameter portion in the axial direction, at least a portion of the large diameter portion being opposite to the external tooth portion in radial directions centered on the central axis; and
the large diameter portion overlaps in the axial direction with an end of the screw or the joining member on an opposite side to the head portion in the axial direction.

7. The transmission according to claim 1, wherein
the cam includes a large diameter portion and a small diameter portion on the first side of the large diameter portion in the axial direction, at least a portion of the large diameter portion being opposite to the external tooth portion in radial directions centered on the central axis;
the cam includes an inner circumferential surface defining the connection hole, and including a recessed portion recessed in the radial directions;
at least a portion of the recessed portion overlaps with the large diameter portion in the axial direction; and
the recessed portion opens at an end of the cam on the second side in the axial direction.

8. An actuator comprising:
the transmission of claim 1; and
a rotary electric machine connected to one of the first shaft and the second shaft.
